(19) United States
(12) Patent Application Publication
(10) Pub. No.: US 2023/0334196 A1
(43) Pub. Date: Oct. 19, 2023

(54) TIME THRESHOLD MODEL CREATION METHOD AND SYSTEM BASED ON AUTONOMOUS BRAKING SYSTEM

(71) Applicant: BEIJING SMARTER EYE TECHNOLOGY CO., LTD, Beijing (CN)

(72) Inventors: Ran MENG, Beijing (CN); Hua CHAI, Beijing (CN); Yanqiu XIA, Beijing (CN); Yong JIA, Beijing (CN); Zhe WANG, Beijing (CN); Chuanbin FENG, Beijing (CN); Yinlong LU, Beijing (CN); Qiao MA, Beijing (CN); Qun WANG, Beijing (CN)

(21) Appl. No.: 18/155,728

(22) Filed: Jan. 17, 2023

(30) Foreign Application Priority Data
Apr. 18, 2022 (CN) 202210401347.1

(51) Int. Cl. G06F 30/20

(52) U.S. Cl. CPC G06F 30/20; G06F 2111/08

(57) ABSTRACT

A time threshold model creation method and a time threshold model creation system based on an autonomous braking system are provided. The method includes the steps of: obtaining braking data about a target vehicle; creating a three-dimensional space in accordance with a braking time, a speed of the target vehicle, and a relative speed, and obtaining a point cloud of the braking data in the three-dimensional space; dividing a two-dimensional plane defined by the speed of the target vehicle and the relative speed into a plurality of statistical regions, and calculating a probability in each statistical region to obtain a fitted probability distribution curve; calculating a time threshold in each statistical region in accordance with the fitted probability distribution curve; and obtaining a target curve surface of the time thresholds in accordance with the distribution of the time threshold in each statistical region in the three-dimensional space.

### TECHNICAL FIELD

The present disclosure relates to the field of assistant driving technology, in particular to a time threshold model creation method and a time threshold model creation system based on an autonomous braking system.

### BACKGROUND

Recently, an Autonomous Emergency Braking (AEB) system and a Collision Mitigation System (CMS) have been widely used, so as to autonomously decelerate or brake a vehicle when a collision accident is about to occur and a driver fails to brake the vehicle, thereby to prevent the occurrence of the collision accident or reduce a loss caused by the collision accident. In most of these systems, a distance between the vehicle and an obstacle ahead of the vehicle or a collision time is obtained through sensors, and then whether the vehicle is to be decelerated or braked autonomously is determined through calculation, so as to control a braking system of the vehicle.

When the vehicle is braked too early, it is able to prevent the occurrence of the collision accident or reduce the loss caused by the collision accident, but a normal driving behavior of the driver is interfered. When the vehicle is braked too late, it is able to reduce the interference on the normal driving behavior of the driver, but it is likely impossible to prevent the occurrence of the collision accident or reduce the loss caused by the collision accident. Hence, there is an urgent need to calculate an appropriate time for braking (or decelerating) the vehicle.

Hence, there is an urgent need to provide a time threshold model creation method and a time threshold model creation system based on an autonomous braking system, so as to accurately calculate a time for braking or decelerating the vehicle through a time threshold model, thereby to provide data for the subsequent braking or decelerating.

### SUMMARY

An object of the present disclosure is to provide a time threshold model creation method and a time threshold model creation system based on an autonomous braking system, so as to accurately calculate a time for braking or decelerating the vehicle through a time threshold model, thereby to provide data for the subsequent braking or decelerating.

In order to achieve the above-mentioned purposes, the present disclosure provides the following technical solutions.

In one aspect, the present disclosure provides in some embodiments a time threshold model creation method based on an autonomous braking system, including: obtaining braking data about a target vehicle, the braking data including a braking time, a speed of the target vehicle, and a relative speed between the target vehicle and a target obstacle; creating a three-dimensional space in accordance with the braking time, the speed of the target vehicle, and the relative speed, and obtaining a point cloud of the braking data in the three-dimensional space; dividing a two-dimensional plane defined by the speed of the target vehicle and the relative speed into a plurality of statistical regions, and calculating a probability in each statistical region in accordance with the point cloud, so as to obtain a fitted probability distribution curve of the braking time in each statistical region; calculating a time threshold in each statistical region through a percentage partitioning algorithm in accordance with the fitted probability distribution curve; and obtaining a target curve surface of the time thresholds in accordance with the distribution of the time threshold in each statistical region in the three-dimensional space.

In a possible embodiment of the present disclosure, the statistical regions are boxes in the two-dimensional plane, and the boxes are obtained through equally dividing the speed of the vehicle and the relative speed.

In a possible embodiment of the present disclosure, the calculating the probability in each statistical region in accordance with the point cloud so as to obtain the fitted probability distribution curve of the braking time in each statistical region includes, with respect to all data points in the point cloud, calculating a probability of each data point in each statistical region so as to obtain the fitted probability distribution curve of the braking time. An x-axis value of the fitted probability distribution curve is the braking time, and a y-axis value of the fitted probability distribution curve is a proportion of the quantity of data points on a target time threshold to all data points in a target region.

In a possible embodiment of the present disclosure, the calculating the time threshold in each statistical region through the percentage partitioning algorithm in accordance with the fitted probability distribution curve includes: obtaining a percentage of data points whose braking time is greater than a target braking time in the target region in all data points in the target region in accordance with the fitted probability distribution curve; determining whether the percentage is greater than or equal to a predetermined percentage, and when the percentage is greater than or equal to the predetermined percentage, taking the target braking time as the time threshold in the target region; and obtaining the time threshold in each statistical region as the target region.

In a possible embodiment of the present disclosure, the predetermined percentage is 88% to 98%.

In a possible embodiment of the present disclosure, the obtaining the target curve surface of the time thresholds in accordance with the distribution of the time threshold in each statistical region in the three-dimensional space includes: taking coordinates of a center of the target region as coordinates of the time threshold in the target region on the two-dimensional plane; forming a target three-dimensional point in accordance with the center of the target region and the time threshold; and obtaining the target curve surface of the time thresholds through a fitting algorithm in accordance with the target three-dimensional points.

In a possible embodiment of the present disclosure, a function of the target curve surface is expressed as T=f(V_{vehicle}, ΔV), where T represents the time threshold, V_{vehicle} represents the speed of the vehicle, ΔV represents the relative speed, and f represents the function for the target curve surface.

In another aspect, the present disclosure provides in some embodiments a time threshold model creation system based on an autonomous braking system, including: a data collection unit configured to obtain braking data about a target vehicle, the braking data including a braking time, a speed of the target vehicle, and a relative speed between the target vehicle and a target obstacle; a point cloud creation unit configured to create a three-dimensional space in accordance with the braking time, the speed of the target vehicle, and the relative speed, and obtain a point cloud of the braking data in the three-dimensional space; a probability calculation unit configured to divide a two-dimensional plane defined by the speed of the target vehicle and the relative speed into a plurality of statistical regions, and calculate a probability in each statistical region in accordance with the point cloud, so as to obtain a fitted probability distribution curve of the braking time in each statistical region; a threshold calculation unit configured to calculate a time threshold in each statistical region through a percentage partitioning algorithm in accordance with the fitted probability distribution curve; and a curve surface creation unit configured to obtain a target curve surface of the time thresholds in accordance with the distribution of the time threshold in each statistical region in the three-dimensional space.

In yet another aspect, the present disclosure provides in some embodiments an intelligent terminal, including a data collection device, a processor and a memory. The data collection device is configured to collect data, the memory is configured to store therein one or more program instructions, and the processor is configured to execute the one or more program instructions so as to implement the above-mentioned method.

In still yet another aspect, the present disclosure provides in some embodiments a computer-readable storage medium storing therein one or more program instructions. The one or more program instructions is executed by a processor so as to implement the above-mentioned method.

According to the time threshold model creation method and system based on the autonomous braking system in the embodiments of the present disclosure, the braking data including the braking time of the target vehicle, the speed of the target vehicle and the relative speed between the target vehicle and the target obstacle is obtained. Next, the three-dimensional space is created in accordance with the braking time, the speed of the target vehicle, and the relative speed, and the point cloud of the braking data in the three-dimensional space is obtained. Next, the two-dimensional plane defined by the speed of the target vehicle and the relative speed is divided into the plurality of statistical regions, and the probability in each statistical region is calculated in accordance with the point cloud, so as to obtain the fitted probability distribution curve of the braking time in each statistical region. Next, the time threshold in each statistical region is calculated through the percentage partitioning algorithm in accordance with the fitted probability distribution curve. Then, the target curve surface of the time thresholds is obtained in accordance with the distribution of the time threshold in each statistical region in the three-dimensional space.

Through the target curve surface of the time thresholds, a braking time threshold corresponding to any speed of the target vehicle and the relative speed is obtained, so as to conveniently and accurately determine a safe distance, and autonomously decelerate or brake the vehicle in the case of an obstacle within the safe distance. As a result, it is able to accurately calculate the time for braking or decelerating the vehicle through the created time threshold model, thereby to provide data for the subsequent braking or decelerating.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

The structure, scale and size shown in the drawings are merely provided to facilitate the understanding of the contents disclosed in the description but shall not be construed as limiting the scope of the present disclosure, so they has not substantial meanings technically. Any modification on the structure, any change to the scale or any adjustment on the size shall also fall within the scope of the present disclosure in the case of not influencing the effects and the purposes of the present disclosure.

FIG. 1 is a flow chart of a time threshold model creation method based on an autonomous braking system according to one embodiment of the present disclosure;

FIG. 2 is a schematic view showing statistical regions on a two-dimensional plane defined by V_{vehicle} and ΔV according to one embodiment of the present disclosure;

FIG. 3 is a diagram of a probability distribution curve of data points in one statistical region according to one embodiment of the present disclosure;

FIG. 4 is a flow chart of a process of calculating a time threshold according to one embodiment of the present disclosure;

FIG. 5 is a schematic view showing time thresholds in one statistical region according to one embodiment of the present disclosure;

FIG. 6 is a schematic view showing coordinates of the time thresholds in the statistical regions on the two-dimensional plane defined by V_{vehicle} and ΔV according to one embodiment of the present disclosure;

FIG. 7 is a schematic view showing a curve surface fitted through the time thresholds according to one embodiment of the present disclosure; and

FIG. 8 is a block diagram of a time threshold model creation system based on an autonomous braking system according to one embodiment of the present disclosure.

### DETAILED DESCRIPTION

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

An object of the present disclosure is to provide a time threshold model creation method based on an autonomous braking system, so as to calculate a time for braking (or decelerating) a vehicle in a more appropriate manner, thereby to provide data for controlling the braking of the vehicle.

In order to create a time threshold model, factors that affect the time threshold model for the autonomous braking system will be described hereinafter.

To be specific, the factors that affect the time threshold model for the autonomous braking system include a speed of a target vehicle V_{vehicle}, and a relative speed ΔV between the target vehicle and an obstacle ahead of the obstacle when the speed of the vehicle is greater than a speed of the obstacle. In other words, the time threshold T is a function of the speed of the target vehicle V_{vehicle} and the relative speed ΔV, i.e., T=f(V_{vehicle},ΔV).

In other words, in a three-dimensional space defined by T, V_{vehicle} and ΔV, T is a three-dimensional curve surface varying along with V_{vehicle} and ΔV. The method in the embodiments of the present disclosure is just used to create the three-dimensional curve surface.

After the creation of the three-dimensional curve surface, it is able to easily obtain the time threshold T in a certain state, thereby to calculate a safe distance S for the target vehicle. A relationship between S and T is expressed as S=T X V_{vehicle}.

When there is an obstacle on a travelling trajectory of the target vehicle and spaced apart from the target vehicle by a distance smaller than the safe distance S, the target vehicle may be braked or decelerated.

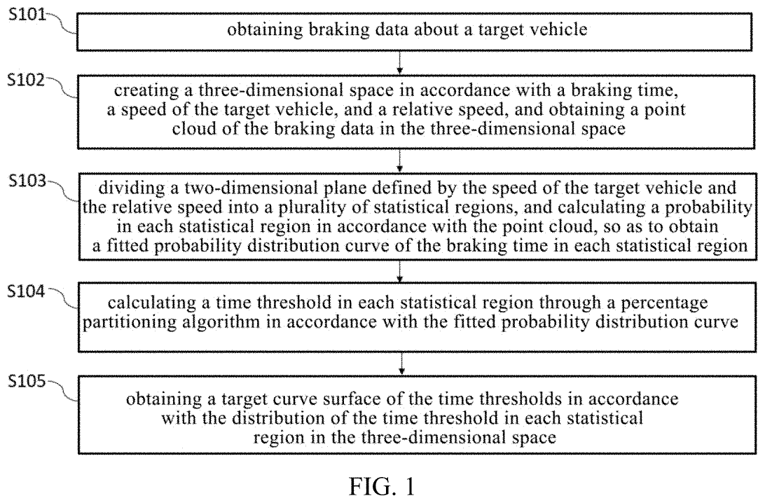

As shown in FIG. 1, the present disclosure provides in some embodiments a time threshold model creation method based on an autonomous braking system, which includes the following steps.

S101: obtaining braking data about a target vehicle, the braking data including a braking time, a speed of the target vehicle, and a relative speed between the target vehicle and a target obstacle.

S102: creating a three-dimensional space in accordance with the braking time, the speed of the target vehicle, and the relative speed, and obtaining a point cloud of the braking data in the three-dimensional space.

In S101 and S102, relevant data about a normal driving operation of a driver is collected. For different vehicles, the time threshold models are different due to different weights of the vehicles and different acceptable deceleration magnitudes. For example, a deceleration magnitude capable of being accepted by a driver and a passenger of a passenger car is large and braking performance of the passenger car is excellent, so the passenger car may be braked late, i.e., the time threshold for braking is small. However, a deceleration magnitude capable of being accepted by a driver and a passenger of a commercial vehicle is small and braking performance of the commercial vehicle is lower than that of the passenger car, so the commercial vehicle may be braked easily, i.e., the time threshold for braking is large. The heavier the vehicle, the earlier the vehicle is braked, i.e., the larger the time threshold for braking. The time threshold model of the autonomous braking system is created with respect to a certain type of vehicle, rather than all types of vehicles.

In actual use, a plurality of AEBs or CMSs is provided for a certain type of vehicle, and key data generated when the vehicle is braked by the driver is recorded within a certain time period (i.e., a predetermined time period). The key data includes the braking time T, the speed of the vehicle V_{vehicle}, and the relative speed ΔV. It should be appreciated that, when the speed of the vehicle is smaller than or equal to 0 or the relative speed is smaller than 0, it is unnecessary to autonomously brake or decelerate the vehicle, so it is unnecessary to record the key data. Each piece of key data is a point in the three-dimensional space defined by T, V_{vehicle} and ΔV. The more the AEBs or CMSs and the longer the predetermined time period, the more the data points. In this way, the point cloud including all data points corresponding to a braking behavior made by the driver in the three-dimensional space.

S103: dividing a two-dimensional plane defined by the speed of the target vehicle and the relative speed into a plurality of statistical regions, and calculating a probability in each statistical region in accordance with the point cloud, so as to obtain a fitted probability distribution curve of the braking time in each statistical region.

To be specific, in order to divide the two-dimensional plane into the regions accurately and simply, the statistical regions are boxes in the two-dimensional plane, and the boxes are obtained through equally dividing the speed of the vehicle and the relative speed. With respect to all data points in the point cloud, a probability of each data point in each statistical region is calculated so as to obtain the fitted probability distribution curve of the braking time in each statistical region. An x-axis value of the fitted probability distribution curve is the braking time, and a y-axis value of the fitted probability distribution curve is a proportion of the quantity of data points on a target time threshold to all data points in a target region.

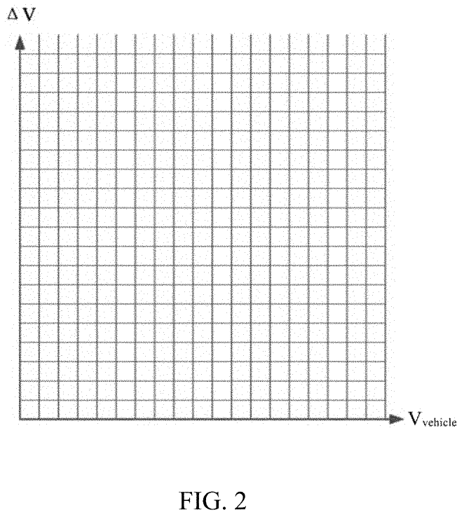

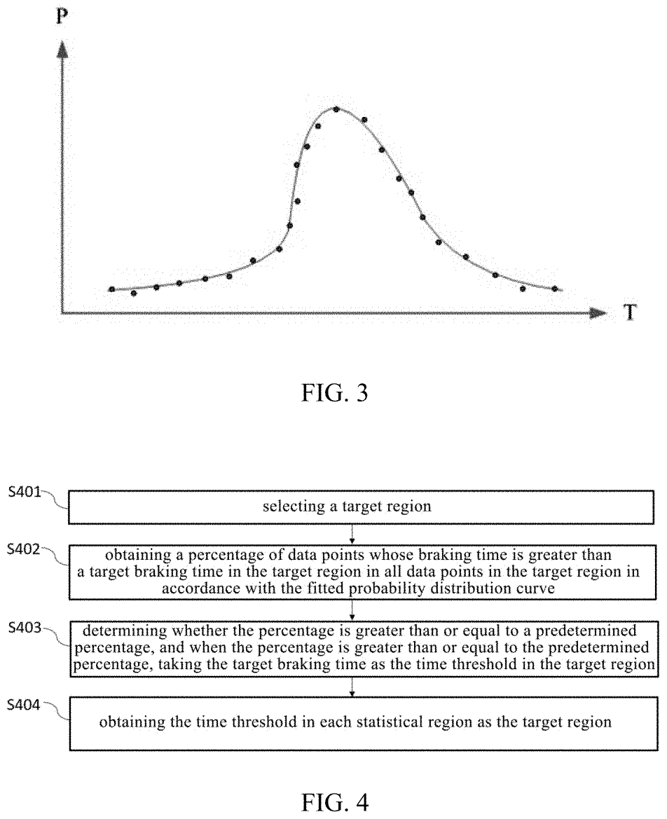

In a specific scenario, at first the two-dimensional plane is divided into a plurality of regions, and these regions are just the statistical regions. As shown in FIG. 2, each box is a statistical unit. It should be appreciated that, within a predetermined range, the more the statistical regions, the better the convergence of the data, but the fewer the data points, and the lower the reliability. The fewer the statistical regions, the more the data points, but the more discrete the data distribution, and the more difficult to obtain a desired value. Hence, the statistical regions may be determined appropriately in accordance with the practical need and the quantity of data points. With respect to all data points, a probability of the data points within each statistical region is calculated on a T-axis, so as to obtain the probability distribution of the data points in each statistical region on the T-axis. Then, the probability distribution curve is fitted in accordance with the discrete probability points. In FIG. 3, an x-axis is the braking time, and a y-axis is the proportion of the quantity of data points on the target time threshold to all data points in the target region.

S104: calculating a time threshold in each statistical region through a percentage partitioning algorithm in accordance with the fitted probability distribution curve. In other words, after obtaining the probability distribution curve of the data points in each statistical region on the T-axis, the time threshold in each statistical region is calculated.

In some embodiments of the present disclosure, as shown in FIG. 4, S104 of calculating the time threshold in each statistical region through the percentage partitioning algorithm in accordance with the fitted probability distribution curve includes: S401 of selecting the target region; S402 of obtaining a percentage of data points whose braking time is greater than a target braking time in the target region in all data points in the target region in accordance with the fitted probability distribution curve; S403 of determining whether the percentage is greater than or equal to a predetermined percentage, and when the percentage is greater than or equal to the predetermined percentage, taking the target braking time as the time threshold in the target region, the predetermined percentage being any value, e.g., a value within a range of 88% to 98%; and S404 of obtaining the time threshold in each statistical region as the target region.

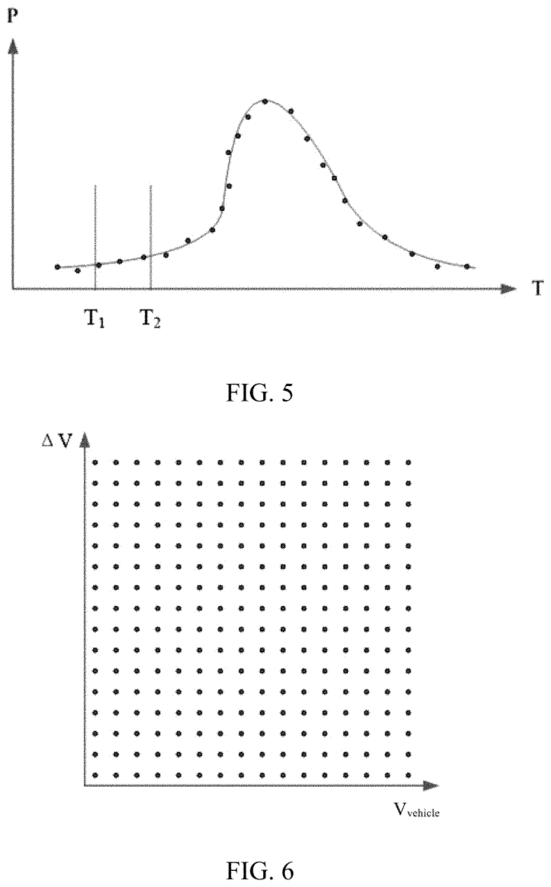

In a specific scenario, when the quantity of data points in each statistical region whose braking time is greater than a target braking time Tₙ needs to be 90% of all the data points in the statistical region, an actual value of Tₙ in the statistical region may be calculated through percentile (P-tile). The larger the actual value of Tₙ, the earlier the vehicle is to be braked or decelerated autonomously, the more the interference on the driver, and the worse the damage reduction effect of the vehicle. In contrast, the smaller the actual value of Tₙ, the later the vehicle is to be braked or decelerated autonomously, the less the interference on the driver, and the better the damage reduction effect of the vehicle. As shown in FIG. 5, as compared with a time threshold T1, on a time threshold T2, the vehicle is to be braked or decelerated autonomously earlier, the damage reduction effect of the vehicle is better, and the more interference is caused on the driver. Generally, the proportion of the data points whose braking time is greater than the braking time Tₙ in the each statistical region to all data points in the statistical region is not smaller than 90%.

Identically, actual values of the time thresholds in the other statistical regions, i.e., T[i] i=0, 1, 2, . . . , n−1, are obtained in a same way, where n represents the quantity of statistical regions.

S105: obtaining a target curve surface of the time thresholds in accordance with the distribution of the time threshold in each statistical region in the three-dimensional space.

In some embodiments of the present disclosure, S105 of obtaining the target curve surface of the time thresholds in accordance with the distribution of the time threshold in each statistical region in the three-dimensional space includes: taking coordinates of a center of the target region as coordinates of the time threshold in the target region on the two-dimensional plane; forming a target three-dimensional point in accordance with the center of the target region and the time threshold; and obtaining the target curve surface of the time thresholds through a fitting algorithm in accordance with the target three-dimensional points.

To be specific, a function of the target curve surface is expressed as T=f(V_{vehicle}, ΔV), where T represents the time threshold, V_{vehicle} represents the speed of the vehicle, ΔV represents the relative speed, and f represents the function for the target curve surface.

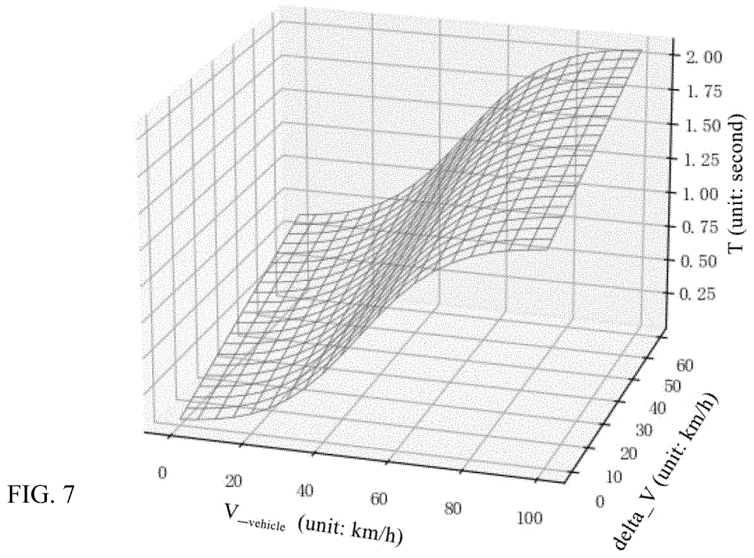

In a specific scenario, the coordinates of the time threshold in each statistical region in the two-dimensional plane are the coordinates of the center of the statistical region, as shown in FIG. 6. At this time, a curve surface is fitted through a fitting algorithm in accordance with the distribution of real values of the time thresholds in the statistical regions in the three-dimensional space, as shown in FIG. 7. The curve surface varies along with V_{vehicle} or ΔV, i.e., it is a function with V_{vehicle} and ΔV as independent variables.

In this way, the time threshold T corresponding to V_{vehicle} and ΔV is obtained, so as to conveniently determine the safe distance S, and autonomously decelerate or brake the vehicle in the case of an obstacle within the safe distance.

According to the time threshold model creation method based on the autonomous braking system in the embodiments of the present disclosure, the braking data including the braking time of the target vehicle, the speed of the target vehicle and the relative speed between the target vehicle and the target obstacle is obtained. Next, the three-dimensional space is created in accordance with the braking time, the speed of the target vehicle, and the relative speed, and the point cloud of the braking data in the three-dimensional space is obtained. Next, the two-dimensional plane defined by the speed of the target vehicle and the relative speed is divided into the plurality of statistical regions, and the probability in each statistical region is calculated in accordance with the point cloud, so as to obtain the fitted probability distribution curve of the braking time in each statistical region. Next, the time threshold in each statistical region is calculated through the percentage partitioning algorithm in accordance with the fitted probability distribution curve. Then, the target curve surface of the time thresholds is obtained in accordance with the distribution of the time threshold in each statistical region in the three-dimensional space.

Through the target curve surface of the time thresholds, a braking time threshold corresponding to any speed of the target vehicle and the relative speed is obtained, so as to conveniently and accurately determine a safe distance, and autonomously decelerate or brake the vehicle in the case of an obstacle within the safe distance. As a result, it is able to accurately calculate the time for braking or decelerating the vehicle through the created time threshold model, thereby to provide data for the subsequent braking or decelerating.

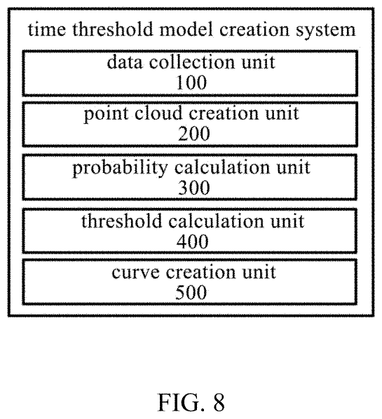

The present disclosure further provides in some embodiments a time threshold model creation system based on an autonomous braking system which, as shown in FIG. 8, includes: a data collection unit 100 configured to obtain braking data about a target vehicle, the braking data including a braking time, a speed of the target vehicle, and a relative speed between the target vehicle and a target obstacle; a point cloud creation unit 200 configured to create a three-dimensional space in accordance with the braking time, the speed of the target vehicle, and the relative speed, and obtain a point cloud of the braking data in the three-dimensional space; a probability calculation unit 300 configured to divide a two-dimensional plane defined by the speed of the target vehicle and the relative speed into a plurality of statistical regions, and calculate a probability in each statistical region in accordance with the point cloud, so as to obtain a fitted probability distribution curve of the braking time in each statistical region; a threshold calculation unit 400 configured to calculate a time threshold in each statistical region through a percentage partitioning algorithm in accordance with the fitted probability distribution curve; and a curve surface creation unit 500 configured to obtain a target curve surface of the time thresholds in accordance with the distribution of the time threshold in each statistical region in the three-dimensional space.

According to the time threshold model creation system based on the autonomous braking system in the embodiments of the present disclosure, the braking data including the braking time of the target vehicle, the speed of the target vehicle and the relative speed between the target vehicle and the target obstacle is obtained. Next, the three-dimensional space is created in accordance with the braking time, the speed of the target vehicle, and the relative speed, and the point cloud of the braking data in the three-dimensional space is obtained. Next, the two-dimensional plane defined by the speed of the target vehicle and the relative speed is divided into the plurality of statistical regions, and the probability in each statistical region is calculated in accordance with the point cloud, so as to obtain the fitted probability distribution curve of the braking time in each statistical region. Next, the time threshold in each statistical region is calculated through the percentage partitioning algorithm in accordance with the fitted probability distribution curve. Then, the target curve surface fitted through the time thresholds is obtained in accordance with the distribution of the time threshold in each statistical region in the three-dimensional space.

Through the target curve surface fitted through the time thresholds, a braking time threshold corresponding to any speed of the target vehicle and the relative speed is obtained, so as to conveniently and accurately determine a safe distance, and autonomously decelerate or brake the vehicle in the case of an obstacle within the safe distance. As a result, it is able to accurately calculate the time for braking or decelerating the vehicle through the created time threshold model, thereby to provide data for the subsequent braking or decelerating.

The present disclosure further provides in some embodiments an intelligent terminal, which includes a data collection device, a processor and a memory. The data collection device is configured to collect data, the memory is configured to store therein one or more program instructions, and the processor is configured to execute the one or more program instructions so as to implement the above-mentioned method.

The present disclosure further provides in some embodiments a computer-readable storage medium storing therein one or more program instructions. The one or more program instructions is executed by a processor so as to implement the above-mentioned method.

In the embodiments of the present disclosure, the processor may be an integrated circuit (IC) having a signal processing capability. The processor may be a general-purpose processor, a Digital Signal Processor (DSP), an Application Specific Integrated Circuit (ASIC), a Field Programmable Gate Array (FPGA) or any other programmable logic element, discrete gate or transistor logic element, or a discrete hardware assembly, which may be used to implement or execute the methods, steps or logic diagrams in the embodiments of the present disclosure. The general purpose processor may be a microprocessor or any other conventional processor. The steps of the method in the embodiments of the present disclosure may be directly implemented by the processor in the form of hardware, or a combination of hardware and software modules in the processor. The software module may be located in a known storage medium such as a Random Access Memory (RAM), a flash memory, a Read-Only Memory (ROM), a Programmable ROM (PROM), an Electrically Erasable PROM (EEPROM), or a register. The processor may read information stored in the storage medium so as to implement the steps of the method in conjunction with the hardware.

The storage medium may be a memory, e.g., a volatile, a nonvolatile memory, or both.

The nonvolatile memory may be an ROM, a PROM, an EPROM, an EEPROM or a flash disk.

The volatile memory may be an RAM which serves as an external high-speed cache. Illustratively but nonrestrictively, the RAM may include Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM) or Direct Rambus RAM (DRRAM).

The storage medium in the embodiments of the present disclosure intends to include, but not limited to, the above-mentioned and any other appropriate memories.

It should be appreciated that, in one or more examples, the functions mentioned in the embodiments of the present disclosure may be achieved through hardware in conjunction with software. For the implementation, the corresponding functions may be stored in a computer-readable medium, or may be transmitted as one or more instructions on the computer-readable medium. The computer-readable medium may include a computer-readable storage medium and a communication medium. The communication medium may include any medium capable of transmitting a computer program from one place to another place. The storage medium may be any available medium capable of being accessed by a general-purpose or special-purpose computer.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A time threshold model creation method based on an autonomous braking system, comprising:
obtaining braking data about a target vehicle, the braking data comprising a braking time, a speed of the target vehicle, and a relative speed between the target vehicle and a target obstacle;
creating a three-dimensional space in accordance with the braking time, the speed of the target vehicle, and the relative speed, and obtaining a point cloud of the braking data in the three-dimensional space;
dividing a two-dimensional plane defined by the speed of the target vehicle and the relative speed into a plurality of statistical regions, and calculating a probability in each statistical region in accordance with the point cloud, so as to obtain a fitted probability distribution curve of the braking time in each statistical region;
calculating a time threshold in each statistical region through a percentage partitioning algorithm in accordance with the fitted probability distribution curve; and
obtaining a target curve surface of the time thresholds in accordance with the distribution of the time threshold in each statistical region in the three-dimensional space,
wherein the calculating the probability in each statistical region in accordance with the point cloud so as to obtain the fitted probability distribution curve of the braking time in each statistical region comprises, with respect to all data points in the point cloud, calculating a probability of each data point in each statistical region so as to obtain the fitted probability distribution curve of the braking time, an x-axis value of the fitted probability distribution curve is the braking time, and a y-axis value of the fitted probability distribution curve is a proportion of the quantity of data points on a target time threshold to all data points in a target region,
wherein the calculating the time threshold in each statistical region through the percentage partitioning algorithm in accordance with the fitted probability distribution curve comprises:
selecting the target region;
obtaining a percentage of data points whose braking time is greater than a target braking time in the target region in all data points in the target region in accordance with the fitted probability distribution curve;
determining whether the percentage is greater than or equal to a predetermined percentage, and when the percentage is greater than or equal to the predetermined percentage, taking the target braking time as the time threshold in the target region; and
obtaining the time threshold in each statistical region as the target region,
wherein the obtaining the target curve surface of the time thresholds in accordance with the distribution of the time threshold in each statistical region in the three-dimensional space comprises:
taking coordinates of a center of the target region as coordinates of the time threshold in the target region on the two-dimensional plane;
forming a target three-dimensional point in accordance with the center of the target region and the time threshold; and
obtaining the target curve surface of the time thresholds through a fitting algorithm in accordance with the target three-dimensional points.

2. The time threshold model creation method according to claim 1, wherein the statistical regions are boxes in the two-dimensional plane, and the boxes are obtained through equally dividing the speed of the vehicle and the relative speed.

3. The time threshold model creation method according to claim 1, wherein the predetermined percentage is 88% to 98%.

4. The time threshold model creation method according to claim 3, wherein a function of the target curve surface is expressed as T=f(V_{vehicle}, ΔV), where T represents the time threshold, V_{vehicle} represents the speed of the vehicle, ΔV represents the relative speed, and f represents the function for the target curve surface.

5. A time threshold model creation system based on an autonomous braking system, comprising:
a data collection unit configured to obtain braking data about a target vehicle, the braking data comprising a braking time, a speed of the target vehicle, and a relative speed between the target vehicle and a target obstacle;
a point cloud creation unit configured to create a three-dimensional space in accordance with the braking time, the speed of the target vehicle, and the relative speed, and obtain a point cloud of the braking data in the three-dimensional space;
a probability calculation unit configured to divide a two-dimensional plane defined by the speed of the target vehicle and the relative speed into a plurality of statistical regions, and calculate a probability in each statistical region in accordance with the point cloud, so as to obtain a fitted probability distribution curve of the braking time in each statistical region;
a threshold calculation unit configured to calculate a time threshold in each statistical region through a percentage partitioning algorithm in accordance with the fitted probability distribution curve; and
a curve surface creation unit configured to obtain a target curve surface of the time thresholds in accordance with the distribution of the time threshold in each statistical region in the three-dimensional space,
wherein the probability calculation unit is further configured to, with respect to all data points in the point cloud, calculate a probability of each data point in each statistical region so as to obtain the fitted probability distribution curve of the braking time, an x-axis value of the fitted probability distribution curve is the braking time, and a y-axis value of the fitted probability distribution curve is a proportion of the quantity of data points on a target time threshold to all data points in a target region,
wherein the threshold calculation unit is further configured to:
select the target region;
obtain a percentage of data points whose braking time is greater than a target braking time in the target region in all data points in the target region in accordance with the fitted probability distribution curve;
determine whether the percentage is greater than or equal to a predetermined percentage, and when the percentage is greater than or equal to the predetermined percentage, take the target braking time as the time threshold in the target region; and
obtain the time threshold in each statistical region as the target region,
wherein the curve surface creation unit is further configured to:
take coordinates of a center of the target region as coordinates of the time threshold in the target region on the two-dimensional plane;
form a target three-dimensional point in accordance with the center of the target region and the time threshold; and
obtain the target curve surface of the time thresholds through a fitting algorithm in accordance with the target three-dimensional points.

6. An intelligent terminal, comprising a data collection device, a processor and a memory, wherein the data collection device is configured to collect data, the memory is configured to store therein one or more program instructions, and the processor is configured to execute the one or more program instructions so as to implement the time threshold model creation method according to claim 1.

7. A computer-readable storage medium storing therein one or more program instructions, wherein the one or more program instructions is executed by a processor so as to implement the time threshold model creation method according to claim 1.
